(19) United States
(12) Patent Application Publication
(10) Pub. No.: US 2023/0058325 A1
(43) Pub. Date: Feb. 23, 2023

(54) ELECTRIC KETTLE

(71) Applicant: MAKITA CORPORATION, Anjo-shi (JP)

(72) Inventor: Yasuyuki FUJIMOTO, Anjo-shi (JP)

(73) Assignee: MAKITA CORPORATION, Anjo-shi (JP)

(21) Appl. No.: 17/868,032

(22) Filed: Jul. 19, 2022

(30) Foreign Application Priority Data
Aug. 20, 2021 (JP) 2021-135182

(51) Int. Cl. A47J 27/21; B01D 29/01; B01D 29/96

(52) U.S. Cl. CPC A47J 27/21191; A47J 27/2105; A47J 27/21183; A47J 27/21175; B01D 29/01; B01D 29/96

(57) ABSTRACT

An electric kettle includes: a body unit having a liquid container and a heating part; a lid unit configured to seal the liquid container via a sealing member; a spout; a liquid passage; an opening/closing valve; and a filter part. The liquid passage is configured such that an inside of the liquid container communicates with the spout via the lid unit. The opening/closing valve is configured to separate from the lid unit by being moved downward, thereby providing communication between the liquid container and the liquid passage, and to abut on the lid unit by being moved upward, thereby blocking the communication between the liquid container and the liquid passage. The filter part is provided in the liquid passage.

### CROSS REFERENCE TO RELATED ART

The present application claims priority to Japanese Patent Application No. 2021-135182 filed on Aug. 20, 2021, the disclosure of which is hereby incorporated by reference in its entirety.

### TECHNICAL FIELD

The present disclosure relates to an electric kettle.

### BACKGROUND

An electric kettle, including a body unit having a liquid container and a heating device for heating liquid in the liquid container, and a lid unit configured to seal the body unit, wherein a liquid passage is provided in the lid unit to discharge liquid from the liquid container to the spout, is known. Japanese Unexamined Patent Application Publication No. 2009-178413 discloses an electric kettle having an opening/closing mechanism that opens and closes a liquid passage by depressing and releasing an operation part provided in the lid unit. In this electric kettle, the liquid passage can be closed by the opening/closing mechanism except when liquid is poured out from the spout, which reduces the possibility that the liquid flows out to the outside when the body unit falls.

It is desired to provide a technique for improving the convenience of an electric kettle in which an opening/closing mechanism is provided to open and close a liquid passage at least part of which is provided within a lid unit configured to seal a kettle body.

### SUMMARY

According to an aspect of the present disclosure, an electric kettle is provided. The electric kettle has a body unit, a lid unit, a spout, a liquid passage, an opening/closing valve and a filter part. The body unit has a liquid container and a heating part. The liquid container has an opening on a top and is configured to store liquid. The spout is configured such that the liquid is poured out therefrom. The heating part is configured to heat the liquid in the liquid container. The lid unit is configured to open and close the opening. The lid unit has a sealing member and is configured to seal the liquid container via the sealing member. The liquid passage is configured such that the inside of the liquid container communicates with the spout via the lid unit. The opening/closing valve is configured to separate from the lid unit by being moved downward, thereby providing communication between the liquid container and the liquid passage, and further configured to abut on the lid unit by being moved upward, thereby blocking the communication between the liquid container and the liquid passage. The filter part is provided in the liquid passage.

According to this aspect, the electric kettle can be provided that has the liquid passage through which liquid flows from the liquid container to the spout via the lid unit, and is configured such that the opening/closing valve provides communication between the liquid container and the liquid passage by separating from the lid unit and blocks the communication between the liquid container and the liquid passage by abutting on the lid unit. The filter part provided in the liquid passage can collect foreign matters such as precipitates precipitated within the liquid container when the electric kettle is in use. Therefore, clean liquid can be poured out from the spout even if foreign matters exist within the liquid container. Thus, the electric kettle can be improved in convenience.

### BRIEF DESCRIPTION OF THE DRAWINGS

FIG. 1 is a perspective view of an electric kettle with a kettle body removed from a power supply unit.

FIG. 2 is a perspective view of the kettle body.

FIG. 3 is a top view of the kettle body.

FIG. 4 is a bottom view of the kettle body.

FIG. 5 is a sectional view taken along line IV-IV in FIG. 3.

FIG. 6 is a partial, enlarged view of FIG. 5, for illustrating the kettle body with an opening/closing valve closed.

FIG. 7 is a view corresponding to FIG. 6, for illustrating the kettle body with an opening/closing valve opened.

FIG. 8 is a perspective view of a lid unit.

FIG. 9 is a sectional view taken along line IX-IX in FIG. 3, for illustrating a locking mechanism.

FIG. 10 is a partial, enlarged view of an upper part in a sectional view taken along line X-X in FIG. 3, for showing a filter part attached to the lid unit.

FIG. 11 is a perspective view of the filter part.

FIG. 12 is a side view of the filter part.

FIG. 13 is a bottom view of the filter part.

FIG. 14 is a front view of the filter part.

FIG. 15 is a top view of the electric kettle.

FIG. 16 is a top view of the power supply unit with a battery pack mounted thereon.

FIG. 17 is a perspective view of a power supply connection part.

FIG. 18 is a schematic, sectional view taken along line XVIII-XVIII in FIG. 15.

### DETAILED DESCRIPTION OF THE EMBODIMENTS

In one non-limiting embodiment according to the present disclosure, the filter part may be provided in a portion of the liquid passage formed in the lid unit.

According to this embodiment, the possibility that foreign matters in the liquid container are poured out from the spout is reduced.

In addition or in the alternative to the preceding embodiment of the present disclosure, the filter part may be removably provided in the liquid passage.

According to this embodiment, a user can easily perform maintenance of the filter part by detaching the filter part from the electric kettle.

In addition or in the alternative to the preceding embodiments of the present disclosure, the filter part may have a handle part (a knob, a tab) configured to be held (pinched) with fingers of a user.

According to this embodiment, the user can easily attach and detach the filter part to and from the electric kettle.

In addition or in the alternative to the preceding embodiments of the present disclosure, the lid unit may have a side wall that is arranged inside the liquid container with the opening of the liquid container closed by the lid unit. The filter part may be provided in a portion of the liquid passage formed in the lid unit such that at least part of the filter part is exposed to an outer peripheral surface of the side wall.

According to this embodiment, maintenance of the filter part can be facilitated. Further, the user can easily visually check the contamination state (degree) of the filter part and thus can perform maintenance of the filter part at an appropriate time.

In addition or in the alternative to the preceding embodiments of the present disclosure, the lid unit may have a locking part. The locking part may be provided in a position not exposed to an outer peripheral surface of the lid unit. The locking part may be configured to position the filter part in a portion of the liquid passage formed in the lid unit and lock the filter part to the lid unit.

According to this embodiment, the possibility that the filter part comes off from the lid unit is reduced even if the electric kettle is tilted, for example, when liquid is poured out from the spout. Further, the locking part can be protected from external impact. This enhances the durability of the locking part and further reduces the possibility that the filter part comes off from the lid unit.

In addition or in the alternative to the preceding embodiments of the present disclosure, the lid unit may have a liquid passage forming part that forms the liquid passage. The locking part may be a hole formed in a wall that forms the liquid passage forming part. The filter part may have a locking projection configured to be locked to the hole.

Generally, in an electric kettle in which a liquid passage is provided within a lid unit and the liquid passage is opened and closed by an opening/closing valve, the structure of the lid unit tends to become complicated. Thus, the structure of the lid unit can be further complicated if a filter is provided in the liquid passage. According to this embodiment, however, the hole is formed in the passage forming part of the lid unit, and the filter part is locked to the lid unit by the locking projection being locked to the hole. Therefore, the filter part can be provided in the liquid passage while suppressing complication of the structure of the lid unit.

In addition or in the alternative to the preceding embodiments of the present disclosure, the filter part may be provided in the liquid passage such that a distance between the filter part and the spout in the liquid passage is shorter than a distance between the filter part and the liquid container in the liquid passage. In other words, a length of the liquid passage from the filter part to the spout may be shorter than a length of the liquid passage from the liquid container to the filter part.

According to this embodiment, the distance from the liquid container to the filter part is relatively long. This allows the filter part to collect foreign matters precipitated not only within the liquid container but also in the liquid passage. Therefore, cleaner liquid can be poured out from the spout.

In addition or in the alternative to the preceding embodiments of the present disclosure, the electric kettle may further have a mounting part configured such that a battery pack is removably coupled thereto. The heating part may be configured to heat the liquid in the liquid container by power supplied from the battery pack coupled to the mounting part.

According to this embodiment, a user can carry the electric kettle to use it at a desired place. Thus, the electric kettle is provided with high convenience.

In addition or in the alternative to the preceding embodiments of the present disclosure, the body unit may further have a power receiving connection part. The electric kettle may further have a power supply unit. The power supply unit may have the mounting part, a power supply base and a power supply connection part. The power supply base may be configured such that the body unit is placed on top thereof. The power supply connection part may be configured to be electrically removably connected to the power receiving connection part. The power supply connection part may be configured to supply power to the heating part via the power receiving connection part from the battery pack coupled to the mounting part.

According to this embodiment, the body unit can be reduced in weight as compared with a structure in which the battery pack is coupled to the body unit. This facilitates handling of the body unit and the lid unit.

In addition or in the alternative to the preceding embodiments of the present disclosure, the power supply unit may further have a plate part extending in an up-down direction. The plate part may have a first surface and a second surface. The power supply base may be arranged on a side of the first surface of the plate part, and the mounting part may be arranged on a side of the second surface of the plate part.

According to this embodiment, the region in which the power supply base is arranged and the region in which the mounting part for mounting the battery pack is arranged can be separated by the plate part. Thus, the possibility that the liquid in the liquid container adheres to the mounting part can be reduced. Furthermore, when a user opens the lid unit and puts liquid into the liquid container while leaving the body unit placed on the power supply base, the possibility that the liquid adheres to the mounting part or the battery pack can be reduced. Thus, the safety and durability of the electric kettle are improved.

### Embodiment

### <Overall Structure of the Electric Kettle>

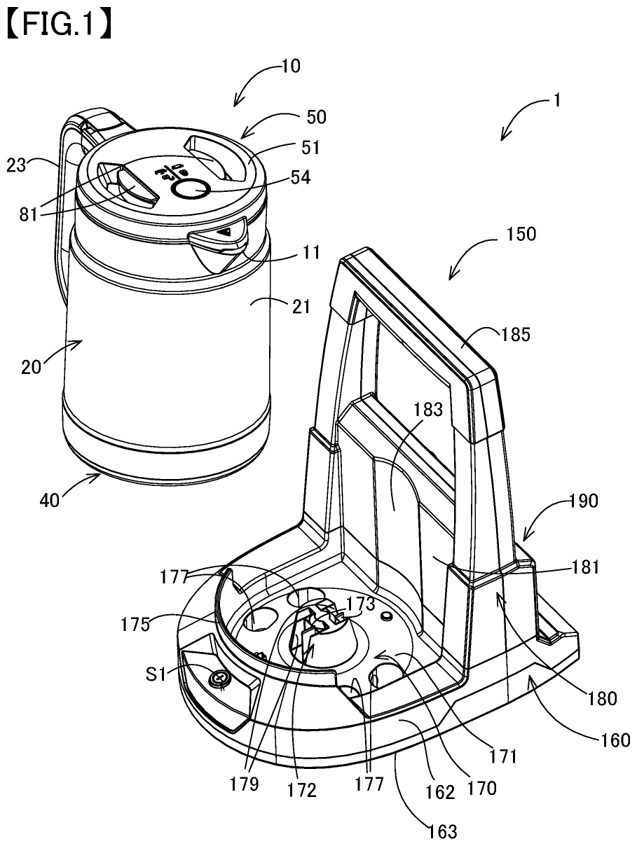

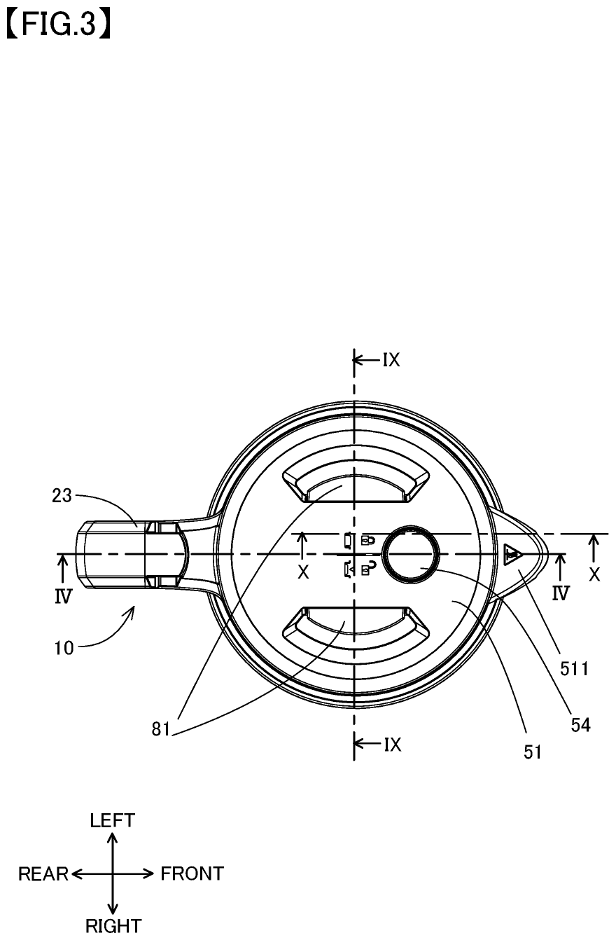

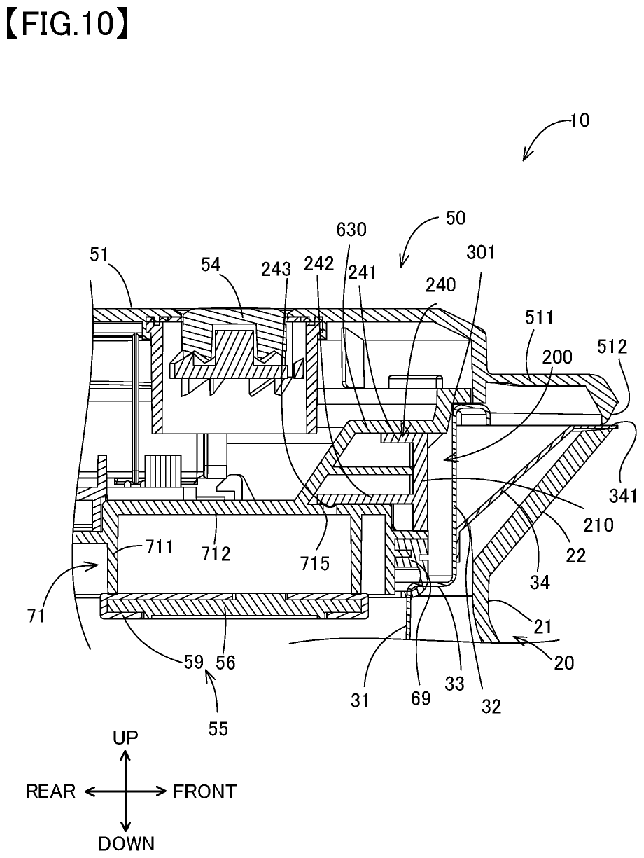

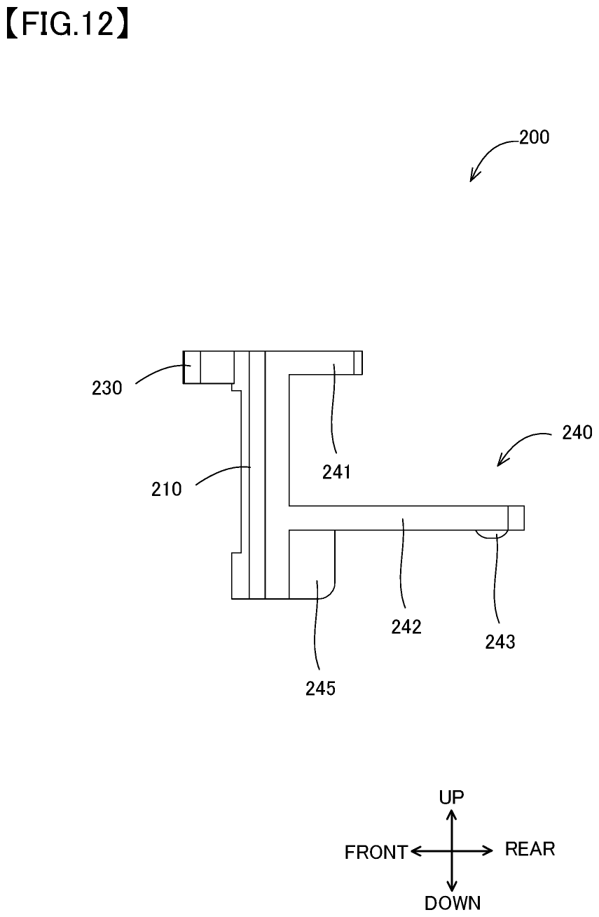

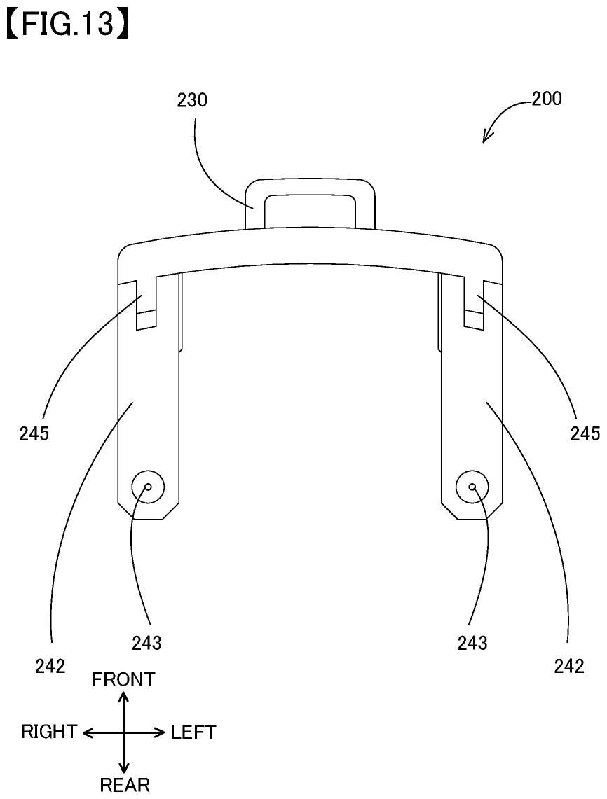

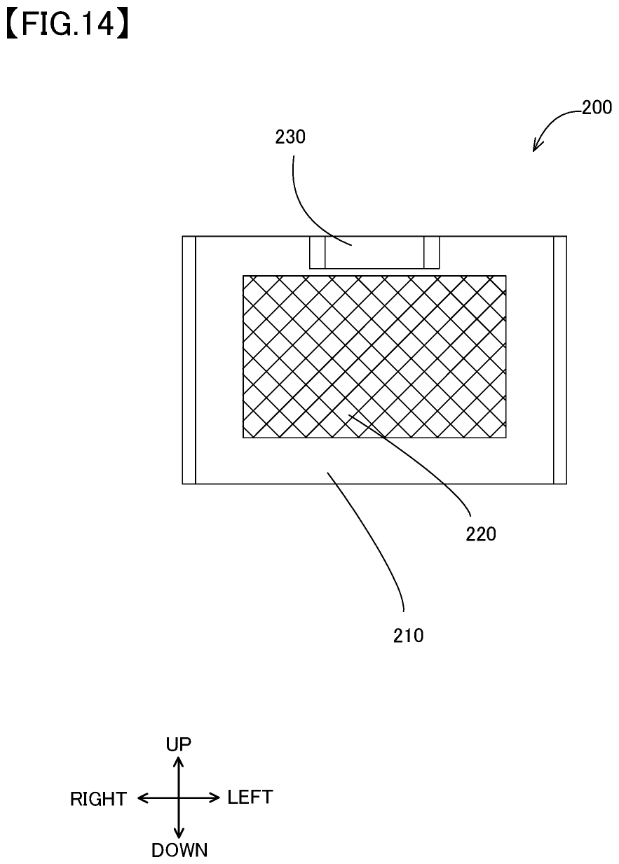

An electric kettle 1 according to an embodiment of the present disclosure is described with reference to FIGS. 1 to 18. The electric kettle 1 includes a kettle body 10 and a power supply unit 150 configured to supply power to the kettle body 10. A user of the electric kettle 1 places the kettle body 10 containing liquid such as water, on a power supply base 170 of the power supply unit 150 having an external power source mounted thereon, and turns on a main switch S1 provided in the power supply unit 150, in order to boil liquid in the kettle body 10.

### <Structure of the Kettle Body>

The kettle body 10 includes a spout 11, a body unit 20 having a kettle grip part 23, and a lid unit 50. When using liquid in the kettle body 10, a user holds the kettle grip part 23 and tilts the kettle body 10 such that the spout 11 faces downward, so that liquid can be poured out from the spout 11.

In the following description, for convenience of explanation, an up-down direction is defined where the side of the lid unit 50 in the kettle body 10 is defined as an upper side and the side of a bottom part 40 of the kettle body 10 is defined as a lower side. Further, an extension direction of an axis that is orthogonal to the up-down direction and that passes through the spout 11 is defined as a front-rear direction. In the front-rear direction, the side of the spout 11 is defined as a front side, while the opposite side is defined as a rear side. A direction orthogonal to the up-down direction and the front-rear direction is defined as a left-right direction.

<Structure of the Body Unit>

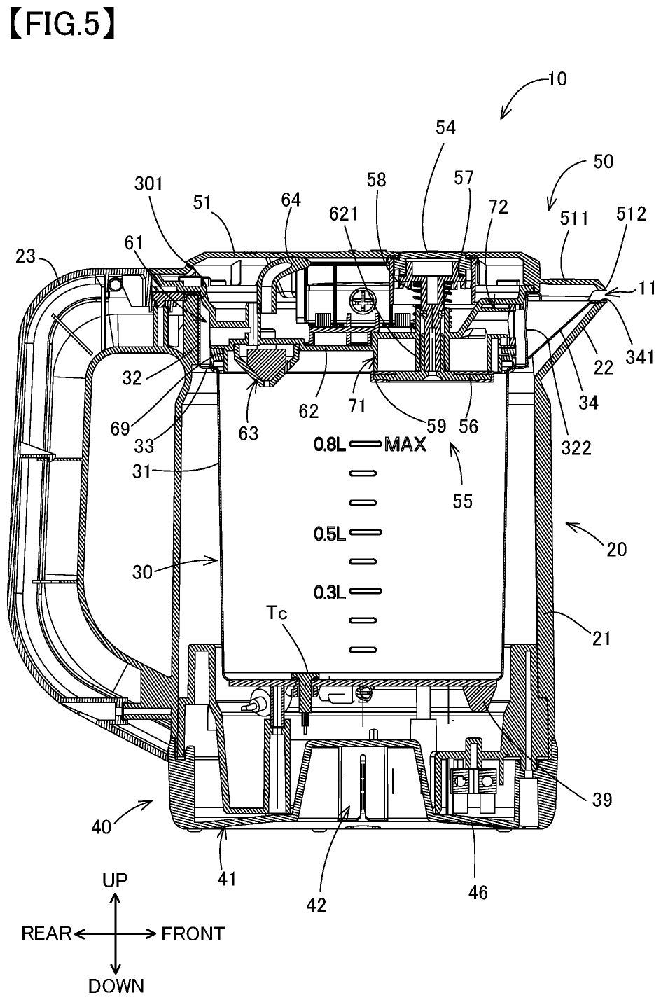

As shown in FIG. 5, the body unit 20 has a bottomed hollow cylindrical shape having an open top, as a whole. The body unit 20 includes a case 21, a kettle grip part 23, a liquid container 30, a heater 39 and a bottom part 40.

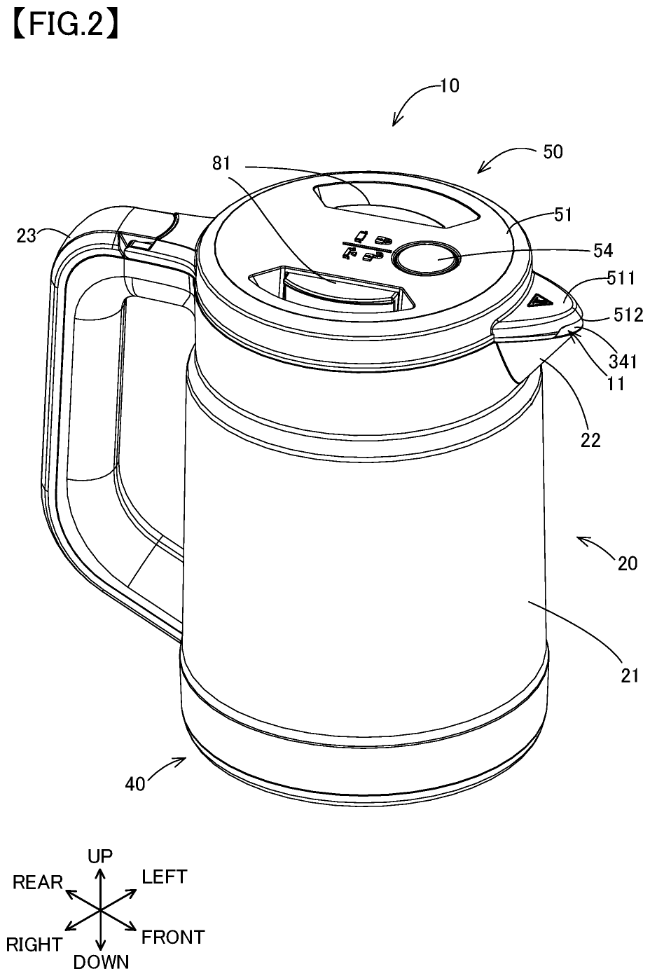

As shown in FIGS. 2 and 5, the case 21 has a hollow cylindrical shape extending in the up-down direction. An outer surface of the case 21 forms an outer peripheral surface of the body unit 20. A protruding part 22 is formed on a front upper end part of the case 21. The protruding part 22 is connected to the case 21 and protrudes obliquely upward and forward from the case 21.

The kettle grip part 23 is configured such that a user can hold the kettle body 10. The kettle grip part 23 extends in the up-down direction. Ends of the kettle grip part 23 are connected to upper and lower end parts of the case 21. The case 21 and the kettle grip part 23 can be formed of metal or resin (polymer).

The liquid container 30 has a bottomed cylindrical shape having an opening 301 on the top and configured to store liquid. As shown in FIG. 5, the liquid container 30 is arranged on the bottom part 40 inside the case 21. The liquid container 30 includes a first part 31, a second part 32 arranged on top of the first part 31 and a connection part 33 for connecting the first and second part 31, 32. The first part 31 of the liquid container 30 is configured to mainly store liquid. A temperature sensor Tc is provided on a bottom of the first part 31. The second part 32 of the liquid container 30 is configured such that part of the lid unit 50 is mainly arranged therein. The second part 32 has an inner diameter and an outer diameter respectively larger than an inner diameter and an outer diameter of the first part 31.

An upper end of the second part 32 (an upper end of the liquid container 30) forms (defines) the opening 301 of the body unit 20. The connection part 33 for connecting the first and second part 31, 32 is formed substantially perpendicularly to the up-down direction.

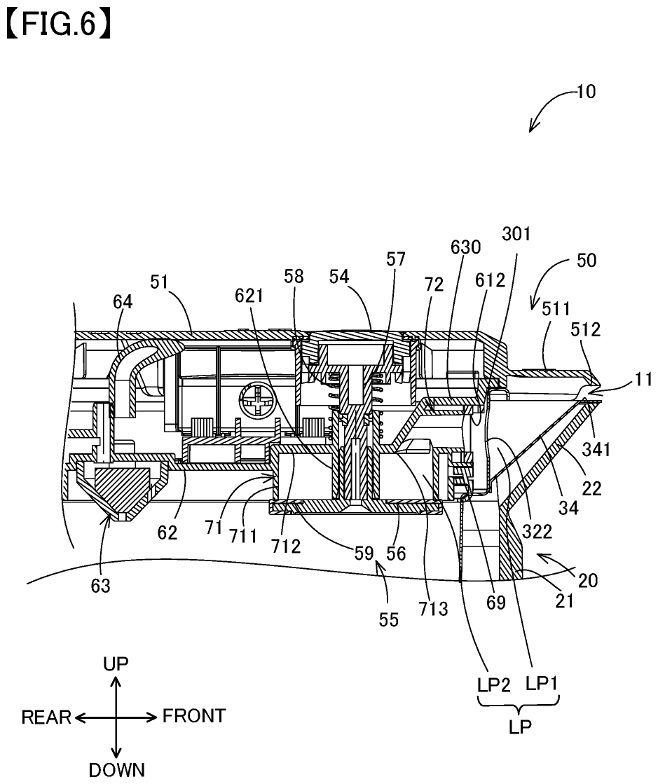

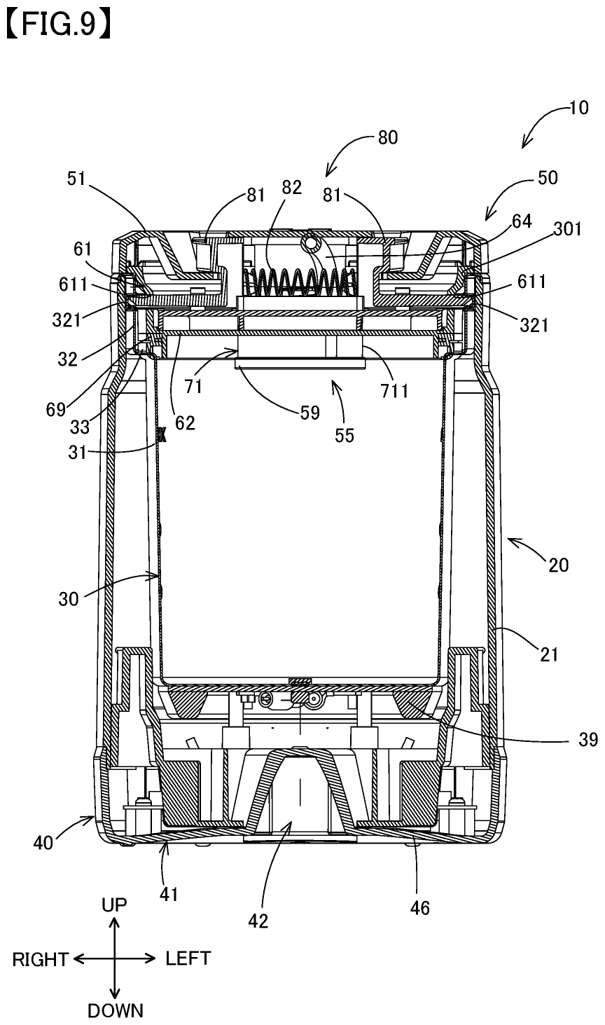

A through hole 322 is formed in a front part (on the spout 11 side) of the second part 32 so as to provide communication between the inside and outside of the second part 32 in the front-rear direction (see FIGS. 5 and 6). Further, as shown in FIG. 9, the second part 32 has a lock lever locking part 321 protruding the liquid container 30 radially outward. The lock lever locking part 321 is configured to lock a lock lever 81 of the lid unit 50. The lock lever 81 will be described in detail below.

A spout forming part 34 is on a front upper end part of the liquid container 30. As shown in FIG. 5, the spout forming part 34 is a portion that is connected to the liquid container 30 and protrudes obliquely upward and forward from the second part 32. The inside of the spout forming part 34 communicates with the inside of the second part 32 (the liquid container 30) via the through hole 322. The spout forming part 34 except a front end 341 is arranged above and inside the protruding part 22. Thus, the spout 11 has a double structure of the protruding part 22 and the spout forming part 34. Further, as shown in FIG. 6, a front end of the protruding part 22 is fixed to the underside of the front end 341 of the spout forming part 34. The front end 341 of the spout forming part 34 defines a front end of the spout 11. A bottom surface of the liquid container 30 is formed of (made of) heat conductive materials such as metal. Inner surfaces of the liquid container 30 and the spout forming part 34 may be coated with heat-resistant resin such as fluororesin.

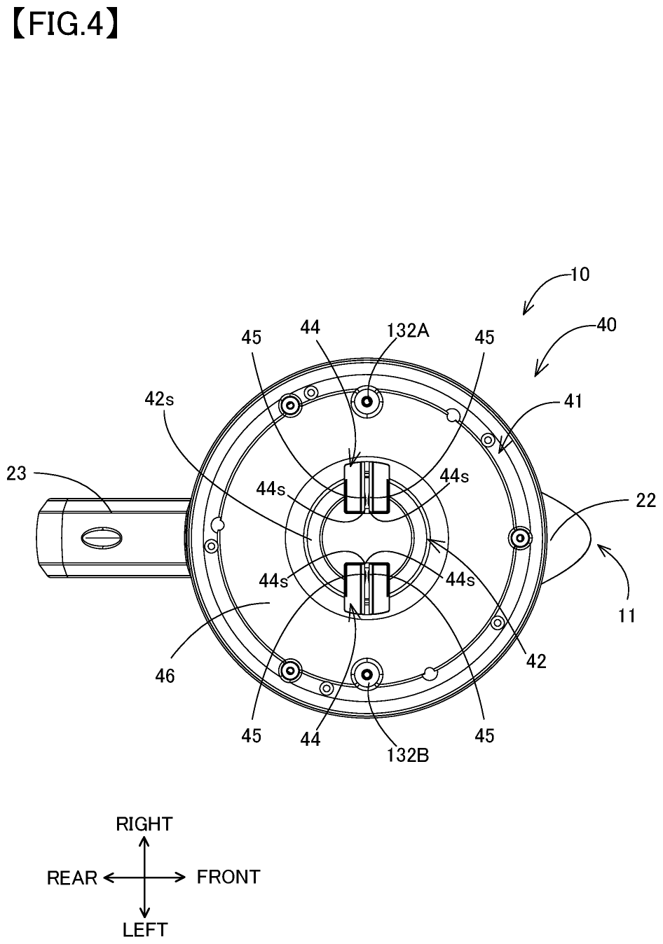

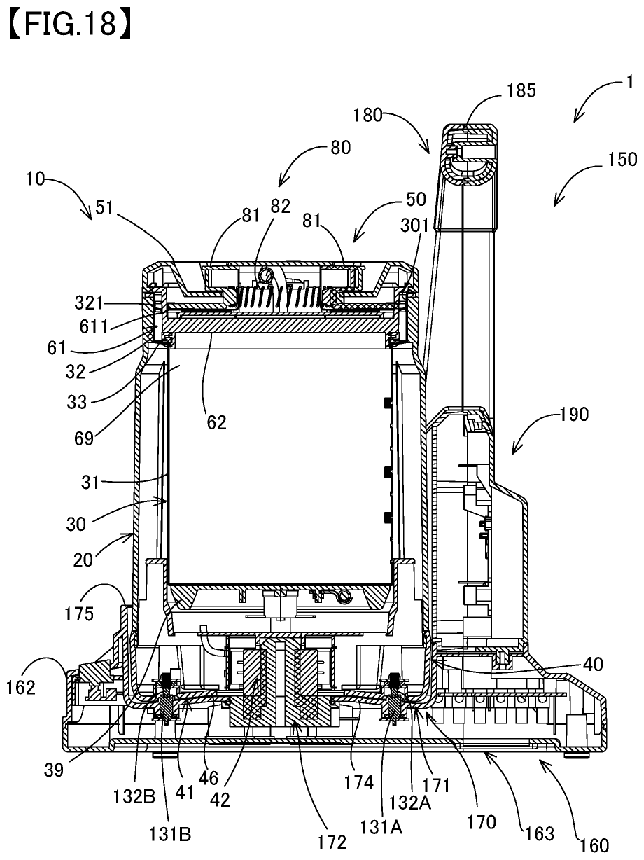

The bottom part 40 is connected to a lower end of the case 21 and forms a bottom part of the kettle body 10. As shown in FIGS. 5 and 9, the heater 39 is installed in the bottom part 40. The bottom part 40 can be formed of metal or resin. As shown in FIG. 4, a power receiving connection part 42 and a pair of terminals (second energizing terminals 132A, 132B) are provided on a lower surface 41 of the bottom part 40. The power receiving connection part 42 is provided on a central portion of the lower surface 41. The lower surface 41 of the bottom part 40 has an inclined face 46 inclined downward and radially outward from the power receiving connection part 42 (see FIG. 18).

The power receiving connection part 42 is described with reference to FIGS. 4 and 5. The power receiving connection part 42 is formed to protrude upward from the lower surface 41. In this embodiment, the power receiving connection part 42 has a generally truncated conical shape having a lower base on the lower side and has a pair of plate-like members 44 protruding from a side face 42s of the truncated conical part toward the center. A power receiving connection terminal 45 that is a conductive member is provided on each of the plate-like members 44. The power receiving connection terminal 45 is configured to receive power from an external power source via a power supply connection part 172 of the power supply unit 150 and supply the power to the heater 39. In this embodiment, the power receiving connection part 42 is configured to restrict movement of the kettle body 10 in cooperation with the power supply connection part 172 when fitted on the power supply connection part 172.

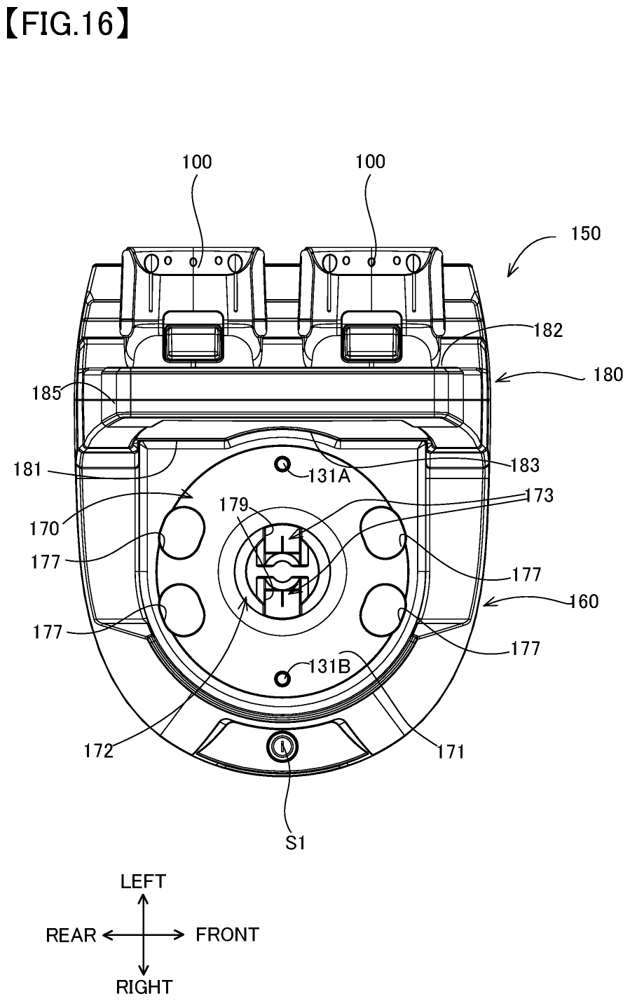

The second energizing terminals 132A, 132B are closer to an outer edge of the lower surface 41 of the kettle body 10 in the radial direction, than to the power receiving connection part 42 and arranged substantially symmetrically to the power receiving connection part 42. The second energizing terminals 132A, 132B are arranged to be connected with first energizing terminals 131A, 131B (see FIGS. 16 and 18) provided on an upper face 171 of the power supply base 170 when the kettle body 10 is placed on the power supply base 170 of the power supply unit 150. In this embodiment, when the kettle body 10 is placed on the power supply unit 150, the second energizing terminals 132A, 132B are respectively connected to the first energizing terminals 131A, 131B of the power supply unit 150 and a circuit for the temperature sensor Tc (see FIG. 5) is formed (closed). The power supply unit 150, the power supply connection part 172 and the first energizing terminals 131A, 131B will be described in detail below.

<Structure of the Lid Unit>

The lid unit 50 is now described mainly with reference to FIGS. 5 to 10. The lid unit 50 is a generally cylindrical member for covering the top of the body unit 20. The lid unit 50 includes an outer lid part 51, an inner lid part 60, an opening/closing valve 55 and a locking mechanism 80.

The outer lid part 51 forms an upper surface of the lid unit 50. As shown in FIGS. 5 to 8, a spout cover 511 is provided in a front end part of the outer lid part 51 and arranged over the spout forming part 34. A front end 512 of the spout cover 511 is spaced apart from the front end 341 of the spout forming part 34 in the up-down direction. A space (opening) defined between the front end 512 of the spout cover 511 and the front end 341 of the spout forming part 34 serves as the spout 11 of the kettle body 10. When using the kettle body 10, the kettle body 10 is tilted such that the spout 11 faces downward, so that liquid in the liquid container 30 is poured out from the spaced part between the front end 512 of the spout cover 511 and the front end 341 of the spout forming part 34. The spout cover 511 and the spout forming part 34 form (define) a first portion LP1 of a liquid passage LP. The liquid passage LP is provided for communication between the inside of the liquid container 30 and the spout 11.

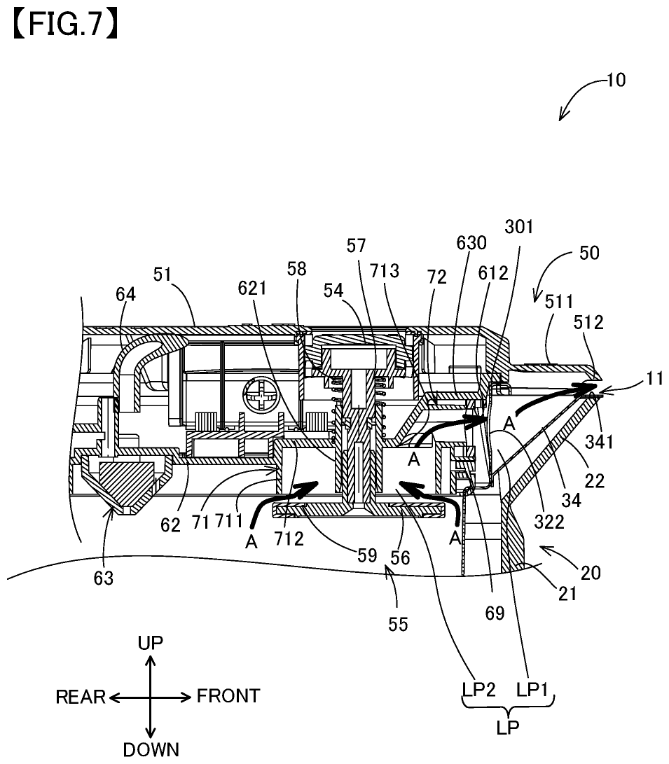

The outer lid part 51 has an opening/closing button 54. As shown in FIGS. 5 to 7, the opening/closing button 54 is connected to a shaft 57 for the opening/closing valve 55. The shaft 57 is inserted into a coil spring 58, and the opening/closing button 54 is biased upward by the coil spring 58. An upper surface of the opening/closing button 54 is normally substantially flush with an upper surface of the outer lid part 51 in the up-down direction. At this time, the opening/closing valve 55 is closed (see FIG. 6). When a user presses down the opening/closing button 54 against the biasing force of the coil spring 58, the opening/closing valve 55 is opened (see FIG. 7). The opening/closing valve 55 will be described in detail below.

The opening/closing button 54 has a locking mechanism (not shown). The locking mechanism is configured to keep the opening/closing button 54 in a locking position when the opening/closing button 54 is pressed down to the locking position. When the opening/closing button 54 is placed in the locking position, the opening/closing valve 55 is maintained in an open state (see FIG. 7). The locking mechanism is configured to return the opening/closing button 54 from the locking position by the biasing force of the coil spring 58 when the opening/closing button 54 is further pressed down from the locking position.

The inner lid part 60 mainly forms a lower portion of the lid unit 50. The inner lid part 60 is configured to cover the opening 301 of the liquid container 30. As shown in FIG. 5, a rear end part of the outer lid part 51 and a rear end part of the inner lid part 60 are removably engaged with the vicinity of an upper end of the kettle grip part 23. The lid unit 50 is configured to be turned about this engaged part to open and close the opening 301 of the body unit 20.

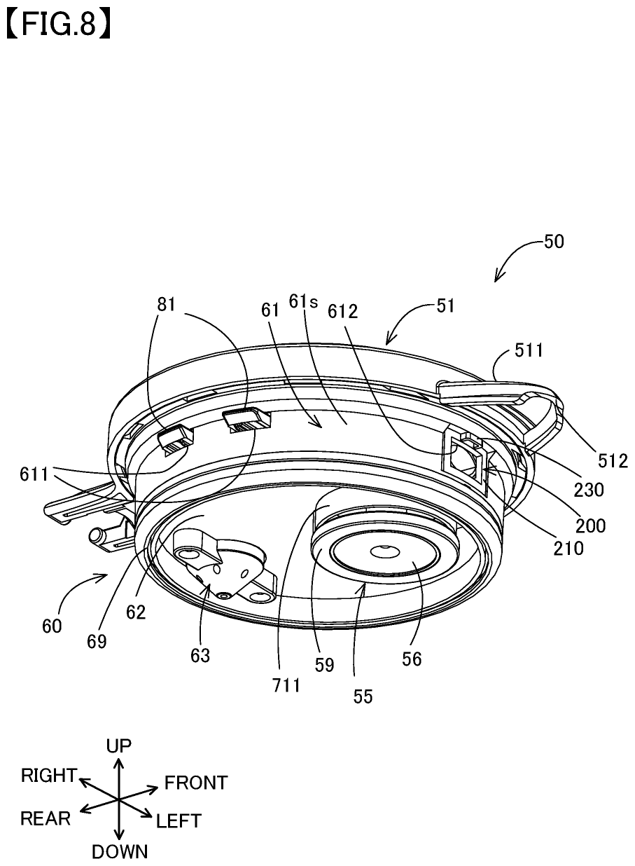

As shown in FIG. 8, the inner lid part 60 has a side wall 61 and a bottom 62. The side wall 61 has a generally annular shape. As shown in FIG. 5, the side wall 61 is arranged inside the second part 32 of the liquid container 30. As shown in FIGS. 8 and 9, the side wall 61 has insertion holes 611. Each of the insertion holes 611 is formed in a position corresponding to the lock lever locking part 321 of the second part 32 and configured to lock the lock lever 81. Further, as shown in FIGS. 6 to 8, a through hole 612 is formed in a front end part of the side wall 61 so as to provide communication between the inside and outside of the inner lid part 60 in the front-rear direction. The through hole 612 is located directly behind the through hole 322 of the liquid container 30 when the lid unit 50 is closed.

A ring-like sealing member 69 is fitted on a lower end part of the side wall 61. When the lid unit 50 is closed, the sealing member 69 abuts on the connection part 33 of the liquid container 30 and thus seals the first part 31 of the liquid container 30.

The bottom 62 of the inner lid part 60 forms a lower surface of the lid unit 50. A lower surface of the bottom 62 forms a top of a part (the first part 31) of the liquid container 30 in which liquid is stored.

A second portion LP2 of the liquid passage LP formed (defined) in the inner lid part 60 is now described with reference to FIGS. 6 and 7. In this embodiment, the inner lid part 60 has a first passage forming part 71 and a second passage forming part 72. The first and second passage forming parts 71, 72 form (define) the second portion LP2 of the liquid passage LP formed in the inner lid part 60.

The first passage forming part 71 is provided in a position corresponding to the opening/closing valve 55. The first passage forming part 71 is configured such that the inside of the liquid container 30 communicates with the inside of the first passage forming part 71 when the opening/closing valve 55 is opened (see FIG. 7), while the communication between the inside of the liquid container 30 and the inside of the first passage forming part 71 is blocked when the opening/closing valve 55 is closed (see FIG. 6). The second passage forming part 72 is configured such that the inside of the first passage forming part 71 communicates with the inside of the spout forming part 34.

The first passage forming part 71 has an annular cylindrical wall 711 protruding downward from the bottom 62, and an upper wall 712 connected to an upper end of the cylindrical wall 711. In this embodiment, the upper wall 712 is located above the lower surface of the bottom 62. An opening 713 is provided in a front portion of the upper wall 712 for communication between the inside of the first passage forming part 71 and the inside of the second passage forming part 72. A tubular part 621 is provided in the center of the upper wall 712 and formed through the upper wall 712 in the up-down direction. The shaft 57 for the opening/closing valve 55 is inserted into the tubular part 621.

The second passage forming part 72 is a part that is configured to connect a portion of the upper wall 712 around the opening 713 with a front end of the side wall 61. In this embodiment, the second passage forming part 72 is a generally tubular wall that connects the vicinity of the opening 713 and the front end of the side wall 61. A front end of the second passage forming part 72 forms the through hole 612 of the side wall 61. Thus, the insides of the first passage forming part 71, the second passage forming part 72 and the spout forming part 34 communicate with each other regardless of the (open or closed) state of the opening/closing valve 55.

The opening/closing valve 55 is arranged under the first passage forming part 71. The opening/closing valve 55 has a valve body 56 and a sealing member 59. The valve body 56 has a generally disc-like shape. The valve body 56 is connected to the opening/closing button 54 via the shaft 57. The sealing member 59 is fitted on the valve body 56 so as to surround an outer periphery of the valve body 56. The opening/closing valve 55 is moved in the up-down direction when the opening/closing button 54 is pressed.

As shown in FIG. 6, when the opening/closing button 54 is not pressed and the opening/closing valve 55 is located in an upper position (i.e. the opening/closing valve 55 is closed), the sealing member 59 is in close contact with a lower end of the cylindrical wall 711 of the first passage forming part 71. Thus, the first part 31 of the liquid container 30 is sealed.

As shown in FIG. 7, when the opening/closing button 54 is pressed and the opening/closing valve 55 is moved downward (i.e. the opening/closing valve 55 is opened), the opening/closing valve 55 is separated downward from the lower end of the cylindrical wall 711. Therefore, liquid in the liquid container 30 can flow into the first passage forming part 71 through a gap between the opening/closing valve 55 and the cylindrical wall 711. As described above, the insides of the first passage forming part 71, the second passage forming part 72 and the spout forming part 34 communicate with each other regardless of the state of the opening/closing valve 55. Therefore, when the opening/closing valve 55 is opened, the inside of the liquid container 30 communicates with the spout 11. Thus, as shown by solid arrows A in FIG. 7, liquid in the liquid container 30 can be poured out from the spout 11 through the liquid passage LP, which is formed by the second portion LP2 formed in the lid unit 50 (the inside of the first passage forming part 71 and the inside of the second passage forming part 72) and the first portion LP1 defined by the spout forming part 34 and the spout cover 511.

As shown in FIGS. 6 to 8, a steam discharge part 63 is provided on the bottom 62. The steam discharge part 63 is configured to discharge steam from the liquid container 30. In this embodiment, one end of a tubular steam passage forming part 64 is connected to the steam discharge part 63. Although not shown, the other end of the steam passage forming part 64 is arranged within the first passage forming part 71, and steam is discharged from the liquid container 30 into the first passage forming part 71 through the steam discharge part 63 and the steam passage forming part 64.

The locking mechanism 80 is now described with reference to FIGS. 2, 3, 8 and 9. The locking mechanism 80 is configured to lock the lid unit 50 to the body unit 20. As shown in FIG. 9, the locking mechanism 80 includes a coil spring 82 arranged to extend in the left-right direction, and a pair of lock levers 81 arranged on the right and left sides of the coil spring 82. The coil spring 82 biases the lock levers 81 in a direction away from each other. A distal end of each of the lock levers 81 is locked in the lock lever locking part 321 of the second part 32 of the liquid container 30 by the biasing force of the coil spring 82.

When a user moves the lock levers 81 in a direction toward each other (toward the center) against the biasing fore of the coil spring 82, the distal ends of the lock levers 81 are disengaged from the lock lever locking part 321. In this state, the user can open the lid unit 50 by turning (pulling up) a front end part (on the spout cover 51 side) of the lid unit 50 about a rear end part of the lid unit 50. Further, the user can remove the lid unit 50 from the body unit 20 by disengaging the rear end part of the lid unit 50 from the upper end of the kettle grip part 23.

<Structure of the Filter Part>

A filter part 200 is now described with reference to FIGS. 8 and 10 to 14. The filter part 200 is provided in the liquid passage LP. The filter part is configured to reduce the possibility that foreign matters in the liquid container 30 are poured out together with liquid. In this embodiment, the filter part 200 is arranged in the second portion LP2 of the liquid passage LP in the lid unit 50. In the following description, the directions of the filter part 200 are defined with reference to the orientation of the filter part 200 mounted to the kettle body 10 (in the mounted state).

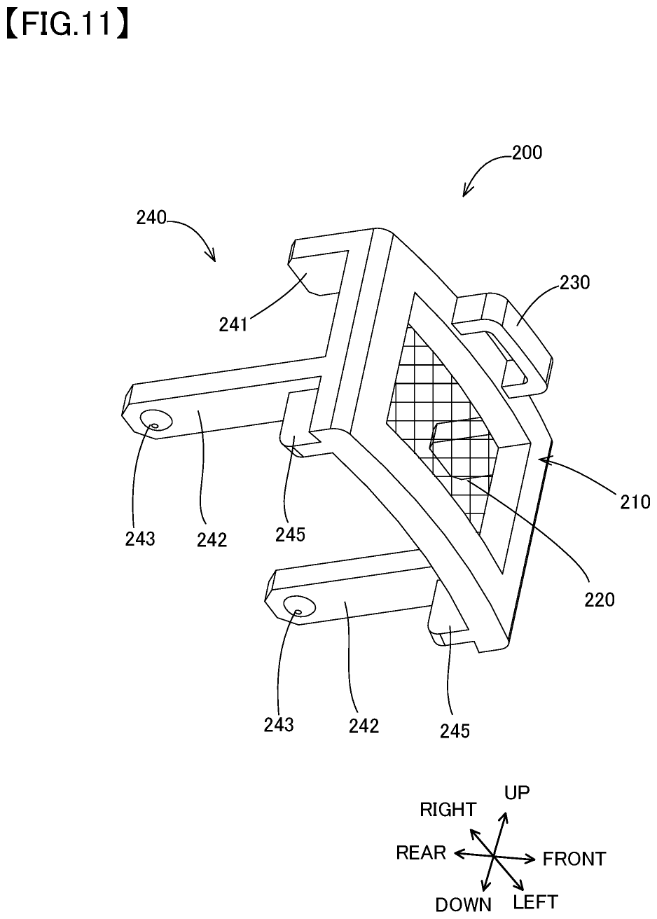

As shown in FIG. 11, the filter part 200 includes a filter body 220, a rectangular frame 210 on the inside of which the filter body 220 is arranged, a handle part (knob, tab) 230 to be held (pinched) with fingers of a user in attaching/detaching the filter part 200 to/from the kettle body 10, and a locking part 240 for locking the filter body 220 to the kettle body 10. The frame 210, the handle part 230 and the locking part 240 are integrally formed as a single member. The frame 210, the handle part 230 and the locking part 240 can be formed, for example, of synthetic resin or metal. In FIG. 8, the filter body 220 is not shown.

As shown in FIG. 8, the filter part 200 is disposed on a front end part of the inner lid part 60 of the lid unit 50. In this embodiment, the filter part 200 is mounted onto the lid unit 50 such that the filter body 220 covers the through hole 612.

As shown in FIG. 8, the frame 210 is formed such that the size (opening area) of the inside of the frame is larger than the opening area of the liquid passage LP (the through hole 612 in this embodiment). The length from an upper end to a lower end (the length in the up-down direction) of the frame 210 is shorter than the length of the side wall 61 of the inner lid part 60 in the up-down direction.

The filter body 220 is a net-like member capable of collecting foreign matters and is arranged on the inside of the frame 210. Compounds of minerals (such as calcium and magnesium) contained in liquid (water) may be precipitated within the liquid container 30. Further, foreign matters (i.e. dust) in the external environment may enter the liquid container 30 when liquid is put into the liquid container 30 from the opening 301. The filter body 220 is configured to prevent these precipitates and foreign matters (which are hereinafter simply referred to as foreign matters) from passing therethrough while allowing liquid to pass therethrough. The filter body 220 is formed of metal. As shown in FIG. 8, a front surface of the frame 210 and the filter body 220 are exposed to an outer peripheral surface 61s of the side wall 61. It can also be said that the frame 210 and the filter body 220 are disposed in the vicinity of the spout forming part 34 in the second passage forming part 72.

The handle part 230 (knob, tab) protrudes forward from a front end upper part of the frame 210. The handle part 230 has a shape suitable to be held (pinched) with fingers of a user. An upper surface of the handle part 230 is substantially flush with an upper surface of the frame 210 in the up-down direction.

The locking part 240 protrudes rearward from a rear end of the frame 210. The locking part 240 is configured such that the filter part 200 can be attached to the lid unit 50. In this embodiment, the locking part 240 is formed of a flexible member and is elastically deformable. In this embodiment, the locking part 240 includes a pair of upper locking parts 241 and a pair of lower locking parts 242. Each of the upper and lower locking parts 241, 242 has a generally plate-like (prismatic) shape having flat upper and lower surfaces and flat left and right surfaces. The upper locking parts 241 protrude rearward from right and left ends of a rear end upper part of the frame 210, respectively. The lower locking parts 242 respectively protrude rearward from right and left frame parts of the frame 210 below the upper locking parts 241. The lower locking parts 242 protrude further rearward than the upper locking parts 241. The thickness (the length in the up-down direction) and the width (the length in the left-right direction) of the upper locking parts 241 are substantially equal to those of the lower locking parts 242. A locking projection 243 is formed on a rear end part of each of the lower locking parts 242 and protrudes downward from the lower surface of the lower locking part 242. A lower end (lower surface) of the lower locking part 242 is supported by a plate piece 245 and connected to a lower end (lower surface) of the frame 210.

The lid unit 50 is configured such that the locking part 240 can be locked to the lid unit 50 in a position not exposed to the outer peripheral surface 61s of the side wall 61. In this embodiment, the inner lid part 60 of the lid unit 50 is configured such that the upper and lower locking parts 241, 242 can be inserted into the inner lid part 60 from the front end of the side wall 61 such that the filter body 220 covers the through hole 612. Further, the inner lid part 60 is configured such that the handle part 230 and the front surface of the frame 210 in the filter part 200 can be exposed from the side wall 61, while the other parts (extending rearward of this front surface) of the filter part 200 and the locking part 240 can be arranged within the lid unit 50. In this embodiment, the inner lid part 60 has an upper wall 630 provided above the second liquid forming part 72. The filter part 200 and the inner lid part 60 are configured such that the upper surfaces of the upper locking parts 241 face the upper wall 630 and the lower surfaces of the lower locking parts 242 face the upper wall 712 of the first passage forming part 71 when the filter part 200 is inserted into the inner lid part 60. The upper wall 712 of the first passage forming part 71 has a hole 715 formed therethrough in the up-down direction. The hole 715 is configured such that the locking projection 243 of each of the lower locking parts 242 can be fitted therein.

In order to attach the filter part 200 to the lid unit 50, the user positions the filter part 200 in front of the through hole 612 of the side wall 61 with the handle part 230 on the upper front side and with the locking part 240 on the rear side. The user holds the handle part 230 with fingers and moves the filter part 200 rearward. In this embodiment, when the filter part 200 is moved rearward, the lower locking part 242 elastically deforms slightly upward by the height of the locking projection 243. When the filter part 200 is further moved rearward until the locking projection 243 reaches the hole 715, the locking projection 243 is fitted into the hole 715, and the lower surface of the lower locking part 242 abuts on the upper wall 712 of the first passage forming part 71. Further, the upper surface of the upper locking part 241 abuts on the upper wall 630 above the second passage forming part 72. In this manner, the locking projection 243 protruding downward from the lower locking part 242 is engaged with the hole 715 and the filter part 200 is locked to the inner lid part 60. This prevents the filter part 200 from moving downward even if the kettle body 10 is tilted such that the spout 11 faces downward when liquid is poured out from the spout 11.

Further, the user can detach the filter part 200 from the lid unit 50 by moving the filter part 200 forward. At this time, in order to detach the filter part 200 from the lid unit 50, the user may disengage the locking projection 243 from the hole 715, for example, by pushing down the filter part 200 and moving it forward.

<Structure of the Power Supply Unit>

The kettle body 10 of this embodiment is configured to supply power to the heater 39 via the power receiving connection part 42 from a battery pack 100 mounted on the power supply unit 150 and heat liquid in the liquid container 30. The power supply unit 150 is now described with reference to FIGS. 1 and 15 to 18.

The power supply unit 150 mainly includes a base part 160, a wall part 180 and a mounting unit 190. The power supply unit 150 can be formed of metal or resin (polymer). The wall part 180 is a generally plate-like member extending upward from the base part 160.

As shown in FIG. 1, the base part 160 is a generally plate-like member extending in the front-rear direction and the left-right direction. A lower surface 163 of the base part 160 can be placed on a flat surface such as a desk, floor or ground.

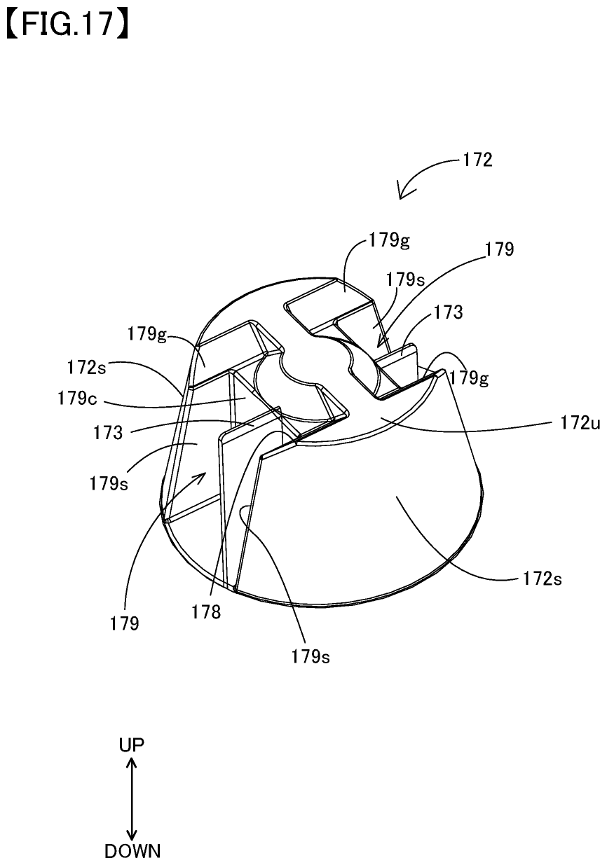

The power supply base 170 is provided in a region of the base part 160 on one surface (first surface) 181 side of the wall part 180. The power supply base 170 is configured such that the bottom part 40 of the kettle body 10 is placed thereon. The bottom part 40 (the lower surface 41) of the kettle body 10 is placed on an upper surface 171 of the power supply base 170. In this embodiment, the upper surface 171 of the power supply base 170 is located below an upper end of a side wall 162 of the base part 160. The area of the power supply base 170 is slightly larger than the area of the bottom part 40 of the kettle body 10. The power supply connection part 172 is provided substantially on a central portion of the upper surface 171 of the power supply base 170. As shown in FIG. 1, the power supply connection part 172 protrudes upward from the upper surface 171. The power supply connection part 172 is configured such that the power receiving connection part 42 of the kettle body 10 is fitted thereon. As shown in FIG. 17, in this embodiment, the power supply connection part 172 has a generally truncated conical shape having a bottom on the lower side and has a pair of notches 179 formed (recessed) from a side face 172s of the truncated conical part toward the center. A power supply connection terminal 173 that is a conductive member is provided in each of the notches 179. The power supply connection terminal 173 supplies power to the kettle body 10 from the battery pack 100 mounted on the mounting unit 190.

As shown in FIG. 17, the notch 179 has a pair of faces 179s connected to the side face 172s, and a face 179c connecting the faces 179s. The faces 179s are substantially parallel to each other in the up-down direction and are opposed across the power supply connection terminal 173. An upper end of each of the faces 179s is located below an upper face 172u of the power supply base 170. The upper end of the face 179s is connected to the upper face 172u via an inclined face 179g. The inclined face 179g is inclined toward the power supply connection terminal 73. The inclined face 179g serves as a guide to move the kettle body 10 in the circumferential direction such that the power receiving connection terminal 45 of the kettle body 10 is connected to the power supply connection terminal 173.

The side face 172s of the power supply connection part 172 is shaped to conform to the side face 42s (see FIG. 4) of the power receiving connection part 42 of the kettle body 10. Specifically, the power supply connection part 172 is configured such that the kettle body 10 can be moved in the circumferential direction while the side face 42s of the power receiving connection part 42 can be moved along the side face 172s of the power supply connection part 172. Further, the power supply connection part 172 is configured to restrict rotation of the kettle body 10 when fitted into the power receiving connection part 42 of the kettle body 10. To restrict rotation herein means that the kettle body 10 is hardly movable in the circumferential direction when placed on the power supply base 170. Being hardly movable means that the kettle body 10 is allowed to move only within a range in which the power receiving connection terminal 45 is held electrically connected to the power supply connection terminal 173. It can also be said that the power supply connection part 172 is configured such that the kettle body 10 cannot rotate when the power supply connection part 172 is fitted in the power receiving connection part 42 of the kettle body 10.

As shown in FIG. 16, a pair of terminals (first energizing terminals 131A, 131B) are provided in the upper surface 171 of the power supply base 70. The first energizing terminals 131A, 131B are closer to an outer edge of the power supply base 170 in the radial direction, than to the power supply connection part 172 and arranged substantially symmetrically to the power supply connection part 172. As shown in FIG. 18, the first energizing terminals 131A, 131B are respectively arranged to be connected to the second energizing terminals 132 A, 132B provided in the lower surface 41 of the kettle body 10 when the kettle body 10 is placed on the power supply base 70.

Each of the plate-like members 44 of the power receiving connection part 42 has a gap extending substantially in the up-down direction and configured such that the power supply connection terminal 173 can be inserted therein (see FIG. 4). The power receiving connection terminal 45 is provided on a pair of faces 44s of the plate-like member 44 that define the gap. When the kettle body 10 is positioned in the circumferential direction relative to the power supply connection part 172 such that the plate-like members 44 are fitted in the notches 179, the power receiving connection terminals 45 are connected to the power supply connection terminals 173, respectively, and movement of the kettle body 10 is restricted.

In this embodiment, as described above, each of the notches 179 of the power supply connection part 172 has the inclined face 179g inclined downward from the upper face 172u of the power supply connection part 172 toward the power supply connection terminal 173. When the plate-like member 44 of the kettle body 10 is located on the inclined face 179g, the kettle body 10 moves downward along the inclined face 179g under its own weight and the plate-like member 44 is fitted in the notch 179. Thus, in the electric kettle 1 according to this embodiment, positioning of the kettle body 10 relative to the power supply unit 50 is completed when the plate-like member 44 is placed on the notch 179 or the inclined face 179g in the circumferential direction. Even if the plate-like member 44 is not placed on the inclined face 179g, a user can move the kettle body 10 in the circumferential direction to place the plate-like member 44 on the inclined face 179g. Thus, the kettle body 10 moves downward along the inclined face 179g under its own weight, so that the positioning of the kettle body 10 is completed.

As shown in FIG. 16, the power supply base 170 has through holes 177 formed through the power supply base 170 in the up-down direction. In this embodiment, the through holes 177 are closer to an outer edge of the power supply base 170, i.e. closer to the outer edge of the power supply base 170 in the radial direction, than to the power supply connection part 172. It can also be said that the through holes 177 are closer to the side wall 162 of the base part 160 and the wall part 180. In this embodiment, four such through holes 177 are provided and arranged substantially symmetrically to the power supply connection part 172.

As shown in FIG. 18, the upper surface 171 of the power supply base 170 has an inclined surface 174 inclined downward from the power supply connection part 172 toward the outside (outer edge) of the power supply base 170. The inclined face 174 is shaped to conform to the inclined surface 46 of the bottom part 40 of the kettle body 10. Thus, the kettle body 10 is stably placed on the power supply base 70.

Returning to description of the power supply base 170, as shown in FIG. 1, a rib 175 is formed in front of the power supply base 170 and protrudes upward from the power supply base 170. The rib 175 is formed in a position to face the (first) surface 181 of the wall part 180. The rib 175 is shaped to conform to the outer edge of the power supply base 170 and the case 21 of the kettle boy 10. The rib 175 restricts forward movement of the kettle boy 10 placed on the power supply base 170. In this embodiment, an upper end of the rib 175 in the up-down direction is located above a lower end of the kettle grip part 23 of the kettle body 10 placed on the power supply base 170.

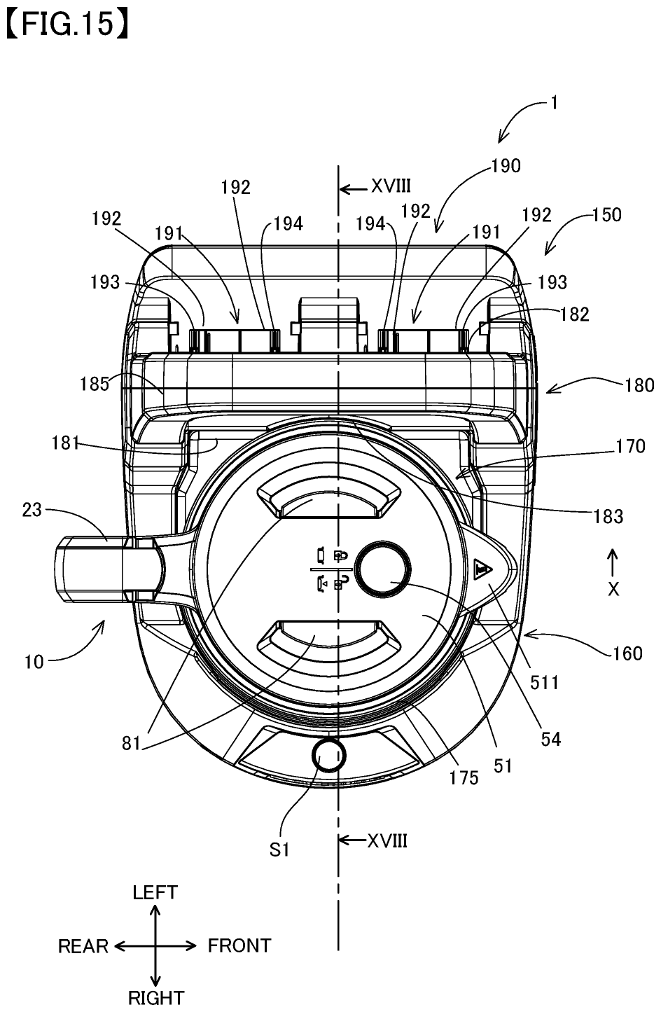

The wall part 180 is now described. In this embodiment, the wall part 180 is a generally plate-like member extending in the up-down direction. The wall part 180 extends upward from the power supply base 170. As shown in FIG. 15, the power supply base 170 is provided in a region on the (first) surface 181 side of the wall part 180, and the mounting unit 190 is provided in a region on the other (a second) surface 182 side of the wall part 180. In this embodiment, the wall part 180 separates the region for the power supply base 170 and the region for the mounting unit 190.

As shown in FIG. 1, the wall part 180 has a power supply unit grip part 185 that is arranged above the mounting unit 190 and configured to be held (gripped, grasped) by the user. The power supply unit grip part 185 is shaped with a through hole extending through the wall part 180. It can also be said that the power supply unit grip part 185 is provided between the mounting unit 190 and the kettle body 10 placed on the power supply base 170 in the left-right direction. As shown in FIG. 18, an upper end of the power supply unit grip part 185 protrudes above the kettle body 10 on the power supply base 170. In this embodiment, the electric kettle 1 is configured such that the center of gravity of the electric kettle 1 is located on or near the wall part 180 irrespective of the amount of liquid in the kettle body 10 when the battery pack 100 is mounted on the mounting unit 190 and the kettle body 10 is on the power supply base 170. Thus, the power supply unit grip part 185 is arranged directly above the center of gravity of the electric kettle 1.

As shown in FIG. 16, the wall part 180 has a recessed part 183 formed in the surface 181 and recessed from the surface 181 toward the surface 182. The recessed part 183 is shaped to conform to the case 21 (the outer peripheral surface 31 of the case 21) of the kettle body 10 placed on the power supply base 170.

The mounting unit 190 is now described with reference to FIG. 15. The mounting unit 190 is provided on a lower part of the (second) surface 182 of the wall part 180. The mounting unit 190 has two mounting parts 191 having the same structure and electrically connected in parallel. Two battery packs 100, for example, each having a nominal voltage of 36 volt can be mounted respectively on the mounting parts 191 and connected. The electric kettle 1 can be driven with power supplied from the mounting unit 190.

The mounting part 191 has a pair of slide rails 192. In this embodiment, the slide rails 192 extend in the up-down direction. A positive input terminal 193 and a negative input terminal 194 are arranged on the slide rails 192.

Rail receiving parts (not shown) of the battery pack 100 are engaged with the slide rails 192 and the battery pack 100 is mounted onto the mounting part 191 by sliding the battery pack 100 in a mounting direction relative to the mounting part 191. In this embodiment, the mounting direction is from up to down. When the battery pack 100 is mounted onto the mounting part 191, the positive input terminal 193 and the negative input terminal 194 of the mounting part 191 are electrically connected to a positive output terminal and a negative output terminal of the battery pack 100.

When the battery pack 100 is slid in a removing direction relative to the mounting part 191, the battery pack 100 is removed from the mounting part 191. In this embodiment, the removing direction is from down to up. Thus, the battery pack 100 can be removably mounted onto the mounting part 191 of the mounting unit 190.

<Effects>

According to this embodiment, the filter part 200 is provided in the liquid passage LP to collect foreign matters such as precipitates precipitated within the liquid container 30. Therefore, clean liquid can be poured out from the spout 11 even if foreign matters exist within the liquid container 30. Thus, the electric kettle 1 can be provided with improved convenience.

The filter part 200 is removably provided in the liquid passage LP (the second portion LP2) of the lid unit 50, so that a user can easily perform maintenance of the filter part 200 by detaching the filter part 200 from the lid unit 50.

Further, the filter part 200 has the handle part 230, so that the user can easily attach and detach the filter part 200 to and from the electric kettle 1.

The filter part 200 is provided in the liquid passage LP (the second portion LP2) such that the handle part 230 and part (the front surface) of the frame 210 are exposed to the outer peripheral surface 61s of the side wall 61. Therefore, the user can easily visually check the contamination state (degree) of the filter body 220 arranged on the inside of the frame 210 and thus can appropriately perform maintenance of the filter part 100.

Further, the filter part 200 is attached to the lid unit 50 such that the handle part 230 and part (the front surface) of the frame 210 in the filter part 200 are exposed to the outer peripheral surface 61s of the side wall 61, while the other parts (extending rearward of the front surface) of the filter part 200 and the locking part 240 are arranged within the lid unit 50. Therefore, the lid unit 50 (the kettle body 10) is provided with excellent design (designability). Further, the possibility of breakage of the locking part 240 is reduced even when the lid unit 50 falls.

Further, the lid unit 50 is configured such that the filter part 200 is locked thereto. This reduces the possibility that the filter part 200 comes off from the lid unit 50, even if the electric kettle 1 is tilted, for example, when liquid is poured out from the spout 11.

In this embodiment, the filter part 200 and the inner lid part 60 are configured such that the upper surface of the upper locking part 241 faces the upper wall 630 and the lower surface of the lower locking part 242 faces the upper wall 712 of the first passage forming part 71 when the filter part 200 is attached to the inner lid part 60. Further, the upper wall 712 of the first passage forming part 71 has the hole 715 formed therethrough in the up-down direction. The hole 715 is configured such that the locking projection 243 of the lower locking part 242 can be fitted therein. Therefore, the locking part 240 and part (the upper wall 712 and the hole 715 of the first passage forming part 71) of the inner lid part 60 to which the locking part 240 is locked can be protected from external impact.

Generally, in an electric kettle in which a liquid passage is provided within a lid unit and the liquid passage is opened and closed by an opening/closing valve, the structure of the lid unit tends to become complicated. Thus, the structure of the lid unit can be further complicated if a filter is provided in the liquid passage. According to this embodiment, however, the hole 715 is formed in a component part (the upper wall 712) of the first passage forming part 71 that forms the liquid passage LP (the second portion LP2) in the lid unit 50, and the filter part 200 is locked to the lid unit 50 by the locking projection 243 being locked to the hole 715. This allows provision of the filter part 200 in the liquid passage LP while suppressing complication of the structure of the lid unit 50.

The electric kettle 1 has the mounting unit 190 configured such that the battery packs 100 can be removably mounted thereon, and the kettle body 10 is configured to supply power from the battery packs 100 to the heater 39. Therefore, a user can use the kettle body 10 at a desired place.

Further, the electric kettle 1 has the kettle body 10 and the power supply unit 150, and the mounting unit 190 is provided on the power supply unit 150. This facilitates handling of the kettle body 10 as compared with a structure in which the battery packs 100 are mounted onto the kettle body 10. Further, with the structure in which the battery packs 100 can be mounted on the power supply unit 150, a user can use the electric kettle 1 at a desired place, so that the degree of freedom of the use environment of the electric kettle 1 is enhanced.

Where the electric kettle 1 is used in an environment such as outdoors and in a machining work site where a relatively large amount of foreign matters (such as dust) exists, the foreign matters may drop into the liquid container 30 when liquid is supplied into the liquid container 30. Even in such a case, by provision of the filter part 200 in the liquid passage LP, liquid from which the foreign matters have been removed is poured from the spout 11.

The power supply unit 150 has the power supply unit grip part 185 extending upward from the power supply base 170 and configured to be held by a user. Therefore, the user can hold the power supply unit grip part 185 and carry the power supply unit 150 alone or carry the kettle body 10 and the power supply unit 150 together. Thus, the electric kettle 1 is provided with high convenience for the user.

The power supply base 170 on which the kettle body 10 is placed is arranged on the (first) surface 181 side of the wall part 180 (the power supply unit grip part 185), and the mounting unit 190 for mounting the battery packs 100 is arranged on the (second) surface 182 side of the wall part 180. Thus, the possibility that liquid to be used for the electric kettle 1 adheres to the mounting unit 190 can be reduced, so that the safety and durability of the electric kettle 1 is improved. Furthermore, when a user opens the lid unit 50 of the kettle body 10 and puts liquid into the kettle body 10 while leaving the kettle body 10 placed on the power supply base 170, the possibility that the liquid adheres to the mounting unit 190 or the battery packs 100 can be reduced. Thus, the safety and durability of the electric kettle 1 are improved, and the degree of freedom in handling of the electric kettle 1 is improved.

The mounting unit 190 has the slide rails 192 extending in the up-down direction and configured such that the battery packs 100 are removably mounted thereon by sliding on the slide rails 192 in the up-down direction. Thus, even if the liquid in the kettle body 10 adheres to the slide rails 192, the liquid can easily drop downward, so that the safety and durability of the electric kettle 1 is further improved.

The power supply unit grip part 185 is arranged above the mounting unit 190 on the wall part 180. Thus, the attitude of the electric kettle 1 can be stabilized with the kettle body 10 placed on the power supply base 170 on the (first) surface 181 side of the wall part 180 and with the battery packs 100 mounted on the (second) surface 182 of the wall part 180. Accordingly, the possibility of tilting of the electric kettle 1 can be reduced when the electric kettle 1 is carried by a user, so that the electric kettle 1 is provided which is easier to carry.

In this embodiment, the electric kettle 1 is configured such that the center of gravity of the electric kettle 1 is located on or near the wall part 180 irrespective of the amount of liquid in the kettle body 10 when the battery packs 100 are mounted on the mounting unit 190 and the kettle body 10 is placed on the power supply unit 150. Thus, the power supply unit grip part 185 is arranged directly above the center of gravity of the electric kettle 1 in use, so that the electric kettle 1 is provided which is further easier to carry.

The power supply unit 150 has the rib 175 protruding upward from the power supply base 170 and facing the surface 181 of the wall part 180. Thus, the possibility that the electric kettle 1 is displaced from the power supply base 170 can be reduced when the electric kettle 1 is carried, so that the electric kettle 1 is provided which is easier to carry.

The power supply base 170 has the through holes 177 formed through the power supply base 170 in the up-down direction. Thus, even if the liquid adheres to the power supply base 170, the liquid can be discharged through the through holes 177. Accordingly, the possibility that the liquid stays on the power supply base 170 can be reduced, so that the safety and durability of the electric kettle 1 is further improved.

The power supply base 170 includes the inclined surface 174 inclined downward from the central portion of the upper surface 171 toward the outer edge of the power supply base 170. Thus, even if the liquid adheres to the power supply base 170, the liquid can flow toward the outer edge. Further, the through holes 177 are arranged closer to the outer edge of the power supply base 170 than to the central portion of the power supply base 170. Thus, the liquid that can flow toward the outer edge is discharged through the through holes 177 arranged close to the outer edge. Accordingly, the possibility that the liquid stays on the power supply base 170 can be further reduced, so that the safety and durability of the electric kettle 1 is furthermore improved.

The wall part 180 of the power supply unit 150 has the recessed part 183, so that the user can place the kettle body 10 on the power supply base 170 along the recessed part 183. Thus, the kettle body 10 is placed in a proper position.

The power receiving connection part 42 of the kettle body 10 and the power supply connection part 172 of the power supply base 170 are configured to be fitted together when the kettle body 10 is placed on the power supply base 170. The power receiving connection part 42 and the power supply connection part 172 are configured to restrict rotation of the kettle body 10 on the power supply base 170 when fitted together. Thus, power can be stably supplied from the power supply unit 150 to the kettle body 10.

The upper end of the rib 175 in the up-down direction is located above the lower end of the kettle grip part 23 of the kettle body 10 placed on the power supply base 170. Thus, the user can place the kettle body 10 on the power supply unit 150 such that the kettle grip part 23 is located between the rib 175 and the wall part 180. Further, in this embodiment, the power receiving connection part 42 and the power supply connection part 172 are configured to be fitted together within a range in which the kettle grip part 23 is located between the rib 175 and the wall part 180 in the front-rear direction. Thus, the rib 175 has a positioning function for properly placing the kettle body 10 on the power supply base 170 in cooperation with the wall part 180. Accordingly, the user can easily place the kettle body 10 in a proper position.

<Correspondences>

Correspondences between the features of the above-described embodiment and the features of the present disclosure are as follows, but the features of the embodiment are merely exemplary and the features of the present disclosure are not limited to them.

The kettle body 10, or the kettle body 10 and the power supply unit 150 (the electric kettle 1) are an example of the “electric kettle”.

The battery pack 100 is an example of the “battery pack”.

The opening 301 is an example of the “opening”.

The liquid container 30 is an example of the “liquid container”.

The heater 39 is an example of the “heating part”.

The body unit 20 is an example of the “body unit”.

The sealing member 69 is an example of the “sealing member”.

The lid unit 50 is an example of the “lid unit”.

The spout 11 is an example of the “spout”.

The inside of the first passage forming part 71, the inside of the second passage forming part 72, the insides of the spout forming part 34 and the spout cover 511 the liquid passage LP, the first portion LP1, the second portion LP2, are examples of the “liquid passage”.

The opening/closing valve 55 is an example of the “opening/closing valve”.

The filter part 200 is an example of the “filter part”.

The handle part 230 is an example of the “handle part”.

The side wall 61 is an example of the “side wall” of the lid unit.

The outer peripheral surface 61s is an example of the “outer peripheral surface of the side wall”.

The hole 715 is an example of the “locking part”.

The first passage forming part 71 and the second passage forming part 72 are examples of the “liquid passage forming part”.

The locking projection 243 is an example of the “locking projection”.

The mounting part 191 is an example of the “mounting part”.

The power receiving connection part 42 is an example of the “power receiving connection part”.

The power supply unit 150 is an example of the “power supply unit”.

The power supply base 170 is an example of the “power supply base”.

The power supply connection part 172 is an example of the “power supply connection part”.

The wall part 180 is an example of the “plate part”.

The surface 181 and the surface 182 are examples of the “first surface” and the “second surface”, respectively.

### Other Embodiments

In the above-described embodiments, the filter part 200 may just be provided in the liquid passage LP, and it may be provided, for example, on the inside of the spout forming part 34 or the spout cover 511 or in the inside of the first passage forming part 71 or the second passage forming part 72.

The structure of locking the filter part 200 to the lid unit 50 is not limited to that of the above-described embodiment (the upper wall 630, the upper wall 712 of the first passage forming part 71, the hole 715), but other structures may also be used.

The filter part 200 need not have the handle part 230. Where the filter part 200 has the handle part 230, the handle part 230 may have a shape other than that described above.

The filter part 200 need not be detachable from the kettle body 10, but may be fixedly held onto the kettle body 10.

The electric kettle 1 need not have the power supply unit 150. For example, the kettle body 10 may have a mounting part for removably mounting the battery pack 100 and be configured to supply power from the battery pack to the heater 39. Power may be supplied to the heater 39 from an external power source other than the battery pack. For example, the kettle body 10 may be configured such that an AC power receptacle can be removably mounted thereto.

Further, in view of the nature of the present disclosure and the above-described embodiment, the following aspects are provided. At least one of the aspects can be employed in combination with any of the above-described embodiment and the claimed invention.

### (Aspect 1)

The body unit includes a spout forming part that is provided on an upper end of the liquid container and forms part of the spout,

the lid unit includes a spout cover that is arranged over the spout forming part and that partially abuts on the spout forming part, and

the spout is defined by a portion of the spout cover and a portion of the spout forming part that are spaced apart from each other.

### (Aspect 2)

The filter part includes a frame, a filter body arranged on an inside of the frame, and a locking part protruding from the frame,

the locking part is locked to an inside of the lid unit, and

a surface of the frame on which the locking part is not arranged and the filter body are arranged along an outer peripheral surface of the lid unit and exposed from the lid unit.

### (Aspect 3)

The lid unit has a first passage forming part that has a cylindrical wall on a lower end of which the opening/closing valve abuts and an upper wall connected to the cylindrical wall, and forms part of the liquid passage.

### (Aspect 4)

The locking part has a locking piece and a locking projection protruding from the locking piece, and

the locking projection is configured to be locked to a hole formed in the upper wall of the first passage forming part.

### (Aspect 5)

The mounting part has a rail that extends in the up-down direction and that is configured such that the battery pack is removably coupled thereto by sliding in the up-down direction.

### (Aspect 6)

The plate part has a grip part that is provided above the mounting part and configured to be held by a user.

### (Aspect 7)

The power supply unit has a rib protruding upward from the power supply base and facing the first surface of the plate part.

### (Aspect 8)

The power supply base has a through hole formed through the power supply base in the up-down direction.

### (Aspect 9)

The power supply connection part is arranged on a central portion of an upper surface of the power supply base,

the upper surface includes an inclined surface inclined downward from the central portion toward an outer edge of the power supply base, and

the through hole is closer to the outer edge of the power supply base than to the central portion.

### (Aspect 10)

The plate part has a recessed part formed in the first surface and recessed from the first surface toward the second surface of the plate part, the recessed part being shaped to conform to a side peripheral surface of the kettle body placed on the power supply base.

### (Aspect 11)

The power receiving connection part of the kettle body and the power supply connection part of the power supply base are configured to be fitted together when the kettle body is placed on the power supply base and to restrict rotation of the kettle body on the power supply base.

The present disclosure is not limited to the above-described embodiments, but may be implemented by a diversity of configurations without departing from the scope of the disclosure. For example, the technical features of any of the above embodiments that correspond to the technical features in the aspects described in “Summary” herein may be replaced or combined appropriately, in order to solve part or all of the problems described above or in order to achieve part or all of the advantageous effects described above. Any of the technical features may be omitted appropriately unless the technical feature is described as essential in the description hereof.

### DESCRIPTION OF THE REFERENCE NUMERALS

1 . . . electric kettle, 10 . . . kettle body, 11 . . . spout, 20 . . . body unit, 21 . . . case, 22 . . . protruding part, 23 . . . kettle grip part, 30 . . . liquid container, 31 . . . first part, 32 . . . second part, 33 . . . connection part, 34 . . . spout forming part, 39 . . . heater, 40 . . . bottom part, 41 . . . lower surface, 42 . . . power receiving connection part, 42s . . . side face, 44 . . . plate-like member, 44s . . . face, 45 . . . power receiving connection terminal, 46 . . . inclined face, 50 . . . lid unit, 51 . . . outer lid part, 54 . . . opening/closing button, 55 . . . opening/closing valve, 56 . . . valve body, 57 . . . shaft, 58 . . . coil spring, 59 . . . sealing member, 60 . . . inner lid part, 61 . . . side wall, 61s . . . outer peripheral surface, 62 . . . bottom, 63 . . . steam discharge part, 64 . . . steam passage forming part, 69 . . . sealing member, 71 . . . first passage forming part, 72 . . . second passage forming part, 80 . . . locking mechanism, 81 . . . lock lever, 82 . . . coil spring, 100 . . . battery pack, 131A . . . first energizing terminal, 132A . . . second energizing terminal, 150 . . . power supply unit, 160 . . . base part, 162 . . . side wall, 163 . . . lower surface, 170 . . . power supply base, 171 . . . upper surface, 172 . . . power supply connection part, 172s . . . side face, 172u . . . upper face, 173 . . . power supply connection terminal, 174 . . . inclined surface, 175 . . . rib, 177 . . . through hole, 179 . . . notch, 179c . . . face, 179g . . . inclined face, 179s . . . face, 180 . . . wall part, 181 . . . surface, 182 . . . surface, 183 . . . recessed part, 185 . . . power supply unit grip part, 190 . . . mounting unit, 191 . . . mounting part, 192 . . . slide rail, 193 . . . positive input terminal, 194 . . . negative input terminal, 200 . . . filter part, 210 . . . frame, 220 . . . filter body, 230 . . . handle part, 240 . . . locking part, 241 . . . upper locking part, 242 . . . lower locking part, 243 . . . locking projection, 245 . . . plate piece, 301 . . . opening, 321 . . . lock lever locking part, 322 . . . through hole, 341 . . . front end, 511 . . . spout cover, 512 . . . front end, 611 . . . insertion hole, 612 . . . through hole, 621 . . . tubular part, 630 . . . upper wall, 711 . . . cylindrical wall, 712 . . . upper wall, 713 . . . opening, 715 . . . hole, S1 . . . main switch, Tc . . . temperature sensor, LP . . . liquid passage, LP1 . . . first portion, LP2 . . . second portion

1. An electric kettle, comprising:
a body unit that has a liquid container having an opening on a top and configured to store liquid, and a heating part configured to heat the liquid in the liquid container,
a lid unit that is configured to close the opening and seal the liquid container via a sealing member,
a spout configured such that the liquid is poured out therefrom;
a liquid passage that is configured such that an inside of the liquid container communicates with the spout via the lid unit;
an opening/closing valve that is configured to separate from the lid unit by being moved downward, thereby providing communication between the liquid container and the liquid passage, and to abut on the lid unit by being moved upward, thereby blocking the communication between the liquid container and the liquid passage; and
a filter part provided in the liquid passage.

2. The electric kettle as defined in claim 1, wherein the filter part is provided in a portion of the liquid passage formed in the lid unit.

3. The electric kettle as defined in claim 1, wherein the filter part is removably provided in the liquid passage.

4. The electric kettle as defined in claim 3, wherein the filter part has a handle part configured to be held with fingers of a user.

5. The electric kettle as defined in claim 1, wherein:
the lid unit has a side wall that is inside the liquid container with the opening of the liquid container closed by the lid unit, and
the filter part is provided in a portion of the liquid passage formed in the lid unit such that at least part of the filter part is exposed to an outer peripheral surface of the side wall.

6. The electric kettle as defined in claim 1, wherein the lid unit has a locking part that is provided in a position not exposed to an outer peripheral surface of the lid unit and configured to position the filter part in a portion of the liquid passage formed in the lid unit and lock the filter part to the lid unit.

7. The electric kettle as defined in claim 6, wherein:
the lid unit has a liquid passage forming part that forms the liquid passage,
the locking part is a hole formed in a wall that comprises the liquid passage forming part, and
the filter part has a locking projection configured to be locked to the hole.

8. The electric kettle as defined in claim 1, wherein the filter part is provided in the liquid passage such that a distance between the filter part and the spout in the liquid passage is shorter than a distance between the filter part and the liquid container in the liquid passage.

9. The electric kettle as defined in claim 1, further comprising:
a mounting part configured such that a battery pack is removably coupled thereto,
wherein:
the heating part is configured to heat the liquid in the liquid container by power supplied from the battery pack coupled to the mounting part.

10. The electric kettle as defined in claim 9, wherein:
the body unit further has a power receiving connection part,
the electric kettle further comprises a power supply unit, and
the power supply unit includes:
the mounting part,
a power supply base configured such that the body unit is placed on top thereof; and
a power supply connection part that is configured to be electrically removably connected to the power receiving connection part provided on the power supply base, and configured to supply power to the heating part via the power receiving connection part from the battery pack coupled to the mounting part.

11. The electric kettle as defined in claim 10, wherein:
the power supply unit further includes a plate part extending in an up-down direction and having a first surface and a second surface,
the power supply base is arranged on a side of the first surface of the plate part, and
the mounting part is arranged on a side of the second surface of the plate part.

12. The electric kettle as defined in claim 1, wherein:
the body unit includes a spout forming part that is provided on an upper end of the liquid container,
the lid unit includes a spout cover that is arranged over the spout forming part and that partially abuts on the spout forming part, and
the spout is defined by a portion of the spout cover and a portion of the spout forming part that are spaced apart from each other.

13. The electric kettle as defined in claim 1, wherein:
the filter part includes a frame, a filter body arranged on an inside of the frame, and a locking part protruding from the frame,
the locking part is locked to an inside of the lid unit, and
a surface of the frame on which the locking part is not arranged and the filter body are arranged along an outer peripheral surface of the lid unit and exposed from the lid unit.

14. The electric kettle as defined in claim 2, wherein the filter part is removably provided in in the portion of the liquid passage.

15. The electric kettle as defined in claim 14, wherein the filter part has a handle part configured to be held with fingers of a user.

16. The electric kettle as defined in claim 15, wherein:
the lid unit has a side wall that is arranged inside the liquid container with the opening of the liquid container closed by the lid unit, and
the filter part is provided in a portion of the liquid passage formed in the lid unit such that at least part of the filter part is exposed to an outer peripheral surface of the side wall.
